(19) United States
(12) Patent Application Publication
(10) Pub. No.: US 2002/0052670 A1
(43) Pub. Date: May 2, 2002

(54) Physical distribution system, photograph image outputting system and physical distribution cost determination apparatus for use in the same

(75) Inventors: Hiroshi Tanaka, Kaisei-machi (JP); Kazuo Shimura, Kaisei-machi (JP); Takeshi Ohkubo, Kaisei-machi (JP)

Correspondence Address: SUGHRUE, MION, ZINN, MACPEAK & SEAS, PLLC, 2100 Pennsylvania Avenue, N.W., Washington, DC, 20037-3202, US

(73) Assignee: FUJI PHOTO FILM CO., LTD.

(21) Appl. No.: 09/984,790

(22) Filed: Oct. 31, 2001

(30) Foreign Application Priority Data
Oct. 31, 2000 (JP) 332879/2000

(51) Int. Cl. G06F 7/00

(52) U.S. Cl. 700/216

(57) ABSTRACT

In a control center, provided are: an order information receiving unit that receives order information; an acceptance area range information receiving unit that receives acceptance area range information of a physician; a deadline information receiving unit that receives deadline information of same; an acceptance point determining unit that determines an acceptance point for each physician based on said acceptance area range and deadline information, so that delivery efficiency is enhanced as a whole; an acceptance point informing unit that informs the physician of the determined acceptance point; and a physical distribution cost determination unit that determines a physical distribution cost for each physician, said cost being that for delivery of IP's desired by same, to the determined acceptance point within the acceptance area range allowable for the physician, so that the physical distribution cost becomes lower as the acceptance area and deadline ranges allowable for the physician become wider.

### BACKGROUND OF THE INVENTION

1. Field of the Invention

The present invention relates to a physical distribution system, a photograph image outputting system, and a physical distribution cost determination apparatus for use in the same, more particularly to an improvement of efficiency in delivering goods desired by a customer as a consumer to a predetermined acceptance point or in outputting a photograph image at a predetermined laboratory.

2. Description of the Prior Art

When a customer as a consumer of goods and a supplier providing the goods are apart from each other, a logistic system (physical distribution system) which sends the goods desired by the customer to a place desired by the customer has conventionally delivered the goods desired by the customer from a provider side to the customer's home or the customer's office for each customer. In such a case, it is unusual that a manufacturer as a provider which manufactures goods sends the goods to a customer's home or a customer's office directly, and it is usual that the goods are sent through many intermediate brokers such as an agent.

For example, in the medical field, a CR apparatus (for example, disclosed in Japanese Unexamined Patent Publication Nos. 55(1980)-12429 and 56(1981)-11395 applied for by this applicant) as an apparatus for forming an image for use in diagnosis has nowadays spread and used for diagnosis in medical settings. When a CR film for use in photographing a radiation image using the CR apparatus is delivered to a clinic that is a customer, the CR film is delivered from a CR film manufacturer to the clinic on a distribution route through a first agent, a secondary agent, . . . and a dealer.

However, when the goods are individually delivered from the supplier that made the goods to the customer's home or the customer's office, a delivery efficiency of the goods is not always satisfactory. Moreover, it is almost impossible to use delivery results for obtaining a demand trend of customers for the supplier that manufactured the goods.

Nowadays, it is well known that, as a core of the foregoing logistic system, the delivery service business have been experiencing significant prosperity. Also in this delivery service business, goods desired by a customer are similarly delivered from a supplier side to a customer's home or a customer's office for each customer, and delivery efficiency is still not satisfactory from the supplier side viewpoint.

As a method to solve such a problem, conceived is the one in which by providing a goods collection point for each of areas of a predetermined range or by using a goods collection point of a home delivery service, goods for all customers in a territory of the good collection point are once collected at the goods collection point, and then the goods are delivered to a customer's home or a customer's office from the goods collection point for each customer. However, also in this method, the fact that the goods are finally delivered to the customer's home and the customer's office for each customer remains the same as in the above-described delivery system. Accordingly, a delivery efficiency which falls within a range of responsibility to be taken by the supplier is still not satisfactory.

In addition to the case of the distribution of tangible goods, such problems occur similarly when transferring electronic data, which is an intangible asset, and outputting of goods desired by many customers, such as a print output in a digital photographic service, are performed in an outputting destination desired by each of the customers.

### SUMMARY OF THE INVENTION

The present invention was made in consideration for the above-described circumstances, and an object of the present invention is to provide a physical distribution system, a photograph image outputting system, and a physical distribution cost determination apparatus for use in the same, which are capable of further enhancing delivery efficiency and an outputting efficiency from the provider's viewpoint in delivering the goods desired by a customer to a predetermined acceptance point or in outputting a photograph image in the form of a print at a predetermined laboratory

The physical distribution system of the present invention is characterized in that, information is received from each customer relating to an acceptance area range that is allowable for each customer to accept the goods, and a certain acceptance point (a delivery destination and an output destination from the supplier side) for the customer is determined among all of the acceptance points within the acceptance area range allowable for the customer to accept the goods, so that a delivery efficiency and an outputting efficiency are enhanced from the supplier (provider)'s viewpoint.

To be more specific, the physical distribution system of the present invention for delivering goods desired by many customers from a supply origin from which the goods are supplied to a predetermined acceptance point, is characterized by comprising: an acceptance area range information receiving unit for receiving information relating to an acceptance area range that is allowable for each of the plurality of customers to accept the goods; and an acceptance point determining unit for determining an acceptance point for each customer among all of the acceptance points within the acceptance area range allowable for the customer based on the received information relating to the acceptance area range that is allowable for the customer to accept the goods, so that a delivery efficiency is enhanced as a whole, wherein the goods desired by the customer are delivered to the determined acceptance point.

Note that, not only are goods directly delivered from the supply origin (the supplier side) to the corresponding acceptance point, but also they may be delivered through a goods collection point including a goods collection point of a home delivery service, which is provided for each area within a predetermined range.

Note that, the goods are not limited to only tangible assets, but also includes intangible assets such as electronic data. The delivery in this case includes a concept for transferring electronic data and the like through a network. Needless to say, a recording medium such as a CD-ROM which stores electronic data is dealt with as goods that are tangible assets. Moreover, the goods desired by each customer may differ from one another.

The acceptance point means one at which the goods of the plurality of customers can be freely deposited, and does not include places which have intimate relationships only with the individual customers such as the customers' homes. The acceptance point should be a home delivery service's branch office or a home delivery service's window or a convenience store or a discount store having a function as the home delivery service's window.

The acceptance area range information receiving unit should allow a plurality of acceptance points (candidates for the acceptance point) to be included within the acceptance area range allowable for the customer.

As determination criteria for enhancing the delivery efficiency as a whole, there are, for example, a total sum of delivery distances, a delivery frequency, and the number of the delivery destinations. The acceptance point for each customer should be determined so that a total delivery cost becomes lower for the supplier by reducing the total sum of the delivery distances, the delivery frequency, or the number of the delivery destinations.

The physical distribution system of the present invention further comprises a deadline information receiving unit for receiving information relating to a deadline allowable for each customer, and the acceptance point determining unit should determine the acceptance point for each customer based also on the information relating to the deadline received so that the delivery cost becomes lower as the range of the deadline is wider.

“The range of the deadline” refers to a time period specified by the customer during which he is able to come to the acceptance point to receive the goods to be delivered thereto.

The information relating to the deadline allowable for the customer may be a deadline time or a range of time (i.e. from a certain date to a certain date).

To prevent trouble between the home delivery service and the customer, it is preferable that the deadline is not a time or date by when the goods must be received by the customer but that by when the goods arrive at the acceptance point.

The physical distribution system of the present invention should further comprise an acceptance point informing unit for informing each customer of the acceptance point determined for said customer.

When the acceptance point is informed to the customer, it is preferable to inform a date (appointed date) when the goods are delivered to the acceptance point and a period of time during which the goods will be available for pick-up at said acceptance point in addition to the acceptance point.

In the physical distribution system of the present invention, the means and a method for delivering the goods desired by the customer from the determined acceptance point to the customer's home and the customer's office are not defined at all, and therefore any means and any method may be employed.

For example, the customer may visit the acceptance point of which she has been informed by the acceptance point informing unit to receive the goods. Alternatively, the following way may be adopted. Specifically, in the case where the acceptance point informing unit is not provided as a system on the goods provider side, when the goods arrive at the acceptance point, a notification of the arrival of the goods at the acceptance point is made from the acceptance point to the customer, and the customer is allowed to visit the acceptance point to receive the goods.

Furthermore, the goods may be delivered from the acceptance point to the customer's home. In this case, the delivery of the goods from the acceptance point to the customer is outside the scope under the physical distribution system of the present invention.

A physical distribution cost determination apparatus of the present invention is for use in a physical distribution system which delivers goods desired by many customers to a predetermined acceptance point from a supply origin supplying the goods, the physical distribution cost determination apparatus comprising: an acceptance area range information receiving unit for receiving information relating to an acceptance area range that is allowable for a plurality of customers; and a physical distribution cost determination unit for determining, based on the received information relating to the acceptance area range allowable for each of the customers, a physical distribution cost for each customer, the physical distribution cost being for the delivery of the goods desired by each customer to the predetermined acceptance point within the acceptance area range that is allowable for each customer, so that the physical distribution cost becomes lower as the acceptance area range allowable for each customer is wider.

Note that, the physical distribution cost is not limited to a single concept as a so-called delivery fee (a transportation fee, a delivery charge and the like), but may be included in the price of the goods.

The sentence “so that the physical distribution cost becomes lower as the acceptance area range allowable for each customer is wider” means that the physical distribution cost becomes lower as the number of the acceptance points (candidates for the acceptance point) included in the acceptance area range allowable for the customer is larger. For example, when one case where the number of the acceptance points included in an acceptance area range is small for a short distance delivery is compared with another case where the number of the acceptance points included in an acceptance area range is large for a long distance delivery, the physical distribution cost is set lower in the latter case. This is because it is considered that the physical distribution cost is partially returned to the customer because of an increase in a degree of freedom for a selection of the acceptance point for the goods provider when determining the acceptance point. With regard to this point, a setting of the physical distribution cost is not simply performed in such a manner that the physical distribution cost is set low for a short distance delivery, and set high for a long-distance delivery.

The physical distribution cost determination apparatus of the present invention further comprises a deadline information receiving unit for receiving information relating to a deadline allowable for the customer, and the physical distribution cost determination unit should determine the physical distribution cost for each customer based on the received information relating to the deadline, so that the physical distribution cost becomes lower as the range of the deadline is wider.

A photograph image outputting system of the present invention performs outputting of a photograph image desired by each of many customers at a laboratory, the photograph image outputting system comprising: an acceptance area range information receiving unit for receiving information relating to an acceptance area range allowable for a plurality of customers; and an acceptance point determining unit for determining for each customer a laboratory which performs the outputting of a photograph image desired by the customer among all of the laboratories within the acceptance area range allowable for the customer, at which the customer receives the photograph image, so that an outputting efficiency of the photograph image is enhanced as a whole, wherein the outputting of the photograph image desired by the customer is performed at the determined laboratory.

Outputting of the photograph image includes all of photographic services desired by the customer, and is not limited to print outputting of a photograph. Outputting of the photograph image includes writing of the photograph to a recording medium such as a CD-ROM, and registering of image data in an image server of a laboratory as one method of a digital photographic service available today.

The acceptance area range information receiving unit should allow a plurality of laboratories (candidates for the laboratory to perform outputting of the photograph image) to be included in an acceptance area range allowable for each customer.

As determination criteria for enhancing the outputting efficiency of the photograph image, there are, for example, a total sum of print outputting time, the total number of the laboratories, and a degree of a load of each laboratory. The laboratory for each customer should be determined so that a total outputting cost becomes lower for the provider by reducing the total sum of the print outputting time and the total number of the laboratories.

The photograph image outputting system of the present invention further comprises a deadline information receiving unit for receiving information relating to a deadline allowable for the customer, and the acceptance point determining unit should determine, based on the received information relating to the deadline, the laboratory for each customer at which the customer receives the photograph image, so that the outputting efficiency is enhanced as a whole.

The photograph image outputting system of the present invention should further comprise an acceptance laboratory informing unit for informing each customer of the laboratory determined for said customer, at which the customer receives the photograph image.

When the customer is informed of the laboratory at which she is to receive the photograph image, it is preferable to inform her of the date (appointed date) when outputting of the photograph image will be completed and a period of time during which said photographs images will be available for pick-up at said laboratory in addition to the determined laboratory.

A photograph image outputting cost determination apparatus of the present invention is for use in the photograph image outputting system which performs outputting of the photograph image desired by a plurality of customers at the predetermined laboratory, the photograph image outputting cost determination apparatus comprising: an acceptance area range information receiving unit for receiving information relating to an acceptance area range allowable for a plurality of customers; and a physical distribution cost determination unit for determining, based on the received information relating to the acceptance area range allowable for a plurality of customers, a physical distribution cost for each customer, the physical distribution cost for the outputting of the photograph image desired by the customer, so that the physical distribution cost becomes lower as the acceptance area range allowable for each customer is wider.

The sentence “so that the physical distribution cost becomes lower as the acceptance area range allowable for each customer is wider” means that the physical distribution cost becomes lower as the number of the laboratories (candidates for the laboratory to perform outputting of the photograph image) included in the acceptance area range allowable for the customer is larger. With regard to this point, the setting of the physical distribution cost is not simply performed in such a manner that the physical distribution cost is set low because the acceptance point is included in a short-distance area range, and set high because the acceptance point is included in a long-distance area range.

The photograph image outputting cost determination apparatus of the present invention further comprises a deadline information receiving unit for receiving information relating to a deadline allowable for the customer, and the physical distribution cost determination unit should determine, based on the received information relating to the deadline, the physical distribution cost for outputting the photograph image desired by the customer, so that the physical distribution cost becomes lower as the range of the deadline is wider.

The physical distribution system of the present invention is constituted so as to receive the information relating to the acceptance area range allowable for the customer and to determine the acceptance point for each customer among all of the acceptance points allowable for the customer based on the received information, thus enhancing the delivery efficiency as a whole. Therefore, the goods desired by each customer can be at least organized for each acceptance point, and hence the delivery efficiency can be enhanced.

If a plurality of acceptance points are included in the acceptance area range that can be designated by the customer, for the point where the candidate acceptance points desired by a plurality of customers overlap, the goods can be delivered to this overlapped point. Accordingly, the delivery frequency can be reduced, and the delivery efficiency can be enhanced. Specifically, within the acceptance area range that the customer previously allowed, it is possible to select the acceptance point convenient for the goods provider from the viewpoint of delivery efficiency, to further enhance the delivery efficiency.

Furthermore, if the acceptance point convenient for the goods provider from the viewpoint of delivery efficiency is selected also in consideration of the deadline, the delivery efficiency can be further enhanced.

The physical distribution cost determination apparatus for use in the physical distribution system receives the information relating to the acceptance area range allowable for the customer (the apparatus may also receive the information relating to the deadline), and determines the physical distribution cost for the goods delivery so that the physical distribution cost becomes lower as the acceptance area range allowable for the customer is wider. Accordingly, it is possible to provide a service in which the enhancement of the delivery efficiency as described above returns to the customer in the form of a reduction in price of the goods. Specifically, when the product price does not include the delivery fee, either the product price or the delivery fee maybe reduced; and when the delivery fee is included in the product price, the product price including the delivery fee therein may be reduced. In addition, since the customer visits the predetermined acceptance point to receive the goods, the final distribution expense can be suppressed, resulting in a reduction of the total delivery cost.

The photograph image outputting system of the present invention is one in which the goods in the foregoing physical distribution system as a consumer item desired by the customer is replaced with photograph image output, and the delivery of the goods to a predetermined acceptance point in the foregoing physical distribution system is replaced with outputting of the photograph image at a predetermined laboratory. The photograph image outputting system can achieve the same effects as those in the foregoing physical distribution system.

Specifically, according to the photograph image outputting system of the present invention, since the outputting of the photograph images desired by each customer can be collectively performed at least at a predetermined laboratory, the outputting efficiency can be enhanced.

If a plurality of laboratories as the acceptance point at which the customer accepts the photograph print are included within the acceptance area range that can be designated by the customer, it is possible to enhance an efficiency of the photograph image outputting in which a data transfer is performed efficiently, by selecting a laboratory convenient for the service provider.

It is possible to provide a service to reduce the print price in proportion to the enhancement of the outputting efficiency. In addition, since the customer visits the predetermined laboratory to accept the print output, the final distribution expense can be suppressed, and hence the total print service cost can be reduced.

### BRIEF DESCRIPTION OF THE DRAWINGS

FIG. 1 is a conceptual diagram showing a first embodiment of a physical distribution system of the present invention.

FIG. 2 is a conceptual diagram showing a second embodiment of the physical distribution system of the present invention.

FIG. 3 is a conceptual diagram showing an embodiment of a photograph image outputting system of the present invention.

### DESCRIPTION OF THE PREFERRED EMBODIMENTS

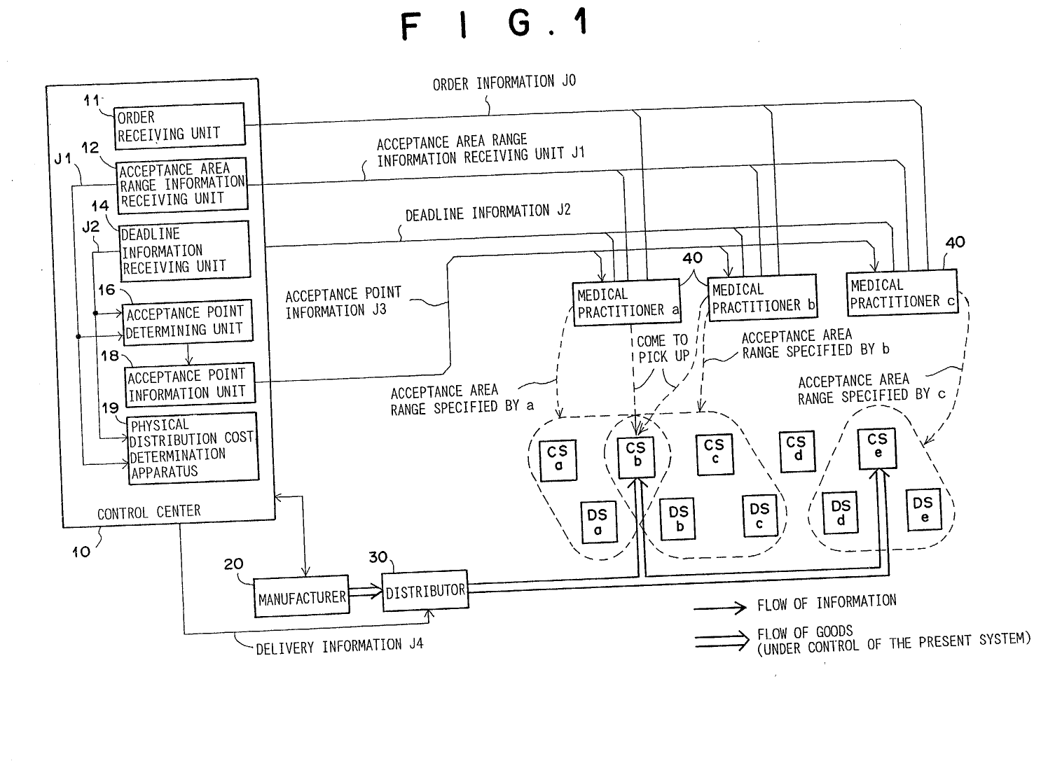

Embodiments of the present invention will be described in detail below with reference to the accompanying drawings. FIG. 1 is a conceptual diagram showing a first embodiment of a physical distribution system of the present invention.

As shown in FIG. 1, the physical distribution system of the first embodiment is one that takes an order from a medical practitioner as a customer who uses a radiation image photograph apparatus as a medical instrument, and that delivers X-ray film as a photographic film used in photographing a radiation image by use of the radiation image photograph apparatus from a manufacturer, who acts as a supply origin of the X-ray film to a predetermined acceptance point. The physical distribution system is constituted by a control center 10 for controlling this system; a manufacturer 20 for manufacturing the X-ray film; a distributor 30 for delivering the X-ray film; medical practitioners 40 (a to c); and convenience stores CS (a to e) and discount stores DS (a to e) functioning as a delivery point (delivery destination and acceptance point) for delivering the X-ray film from the distributor 30 to each of the medical practitioners 40.

In the control center 10, provided are an order receiving unit 11 for receiving order information J0 relating to the X-ray film or other goods, and the number thereof desired by the medical practitioner 40; an acceptance area range information receiving unit 12 for receiving information J1 relating to an acceptance area range that is allowable for the medical practitioner 40 to accept the goods (hereinafter referred to as acceptance area range information); a deadline information receiving unit 14 for receiving information J2 relating to a deadline that is allowable for the medical practitioner 40 to accept the goods (hereinafter referred to as deadline information); an acceptance point determining unit 16 for determining, based on the acceptance area range information J1 and the deadline information J2 for the medical practitioner 40 which have been received by the units 11 and 12, an acceptance point for the medical practitioner 40 among all acceptance points within the acceptance area range that is allowable for the medical practitioner 40 to accept the goods, so that a delivery efficiency is enhanced as a whole; an acceptance point informing unit 18 for informing each medical practitioner 40 of the acceptance point determined for said medical practitioner 40; and a physical distribution cost determination unit 19 for determining, based on the acceptance area range information J1 and the deadline information J2 for the medical practitioner 40 which have been received, a physical distribution cost for delivering an Imaging Plate (hereinafter referred to as IP) desired by the medical practitioner 40 to the predetermined delivery point within the acceptance area range that is allowable for the medical practitioner 40 to accept the goods, that is, the acceptance point, so that the physical distribution cost becomes lower as the acceptance area range and the deadline range that are allowable for the medical practitioner 40 are wider. As is understood from the constitution of the control center 10, the control center 10 also functions as the physical distribution cost determination apparatus of the present invention.

In the physical distribution system of the first embodiment, in accordance with the locations of each medical practitioner 40 participating in this system, a plurality of delivery points including a convenience store and a discount store are always set up within the acceptance area range that is allowable for the medical practitioner 40 in advance, so that they are included as candidates for actual acceptance points. This means that even when data are input, indicating that the acceptance area range allowable for the medical practitioner 40 is, for example, within 10 Km from the location of the medical practitioner 40, the plurality of acceptance points are included within the acceptance area range desired by the medical practitioner 40. On the contrary, when an arrangement of the convenience store CS and the discount store DS as the acceptance point is restricted from the viewpoint of the system constitution, an allowable distance from the seat of the medical practitioner 40 to the delivery point is set. Thus, the acceptance area range information receiving unit 12 can urge the medical practitioner 40 to select the acceptance area range so that the plurality of delivery points are included in the acceptance area range desired by the medical practitioner 40.

Note that, in the first embodiment, a personal computer in which control software for controlling this system is installed is used as a terminal device which functions as the order receiving unit 11, the acceptance area range information receiving unit 12, the deadline information receiving unit 14, the acceptance point determining unit 16, the acceptance point informing unit 18, and the physical distribution cost determination unit 19.

The medical practitioner 40 is provided with a terminal device to which is input the order information J0, the acceptance area range information J1, and the deadline information J2; delivers the information J0 to J2 to the control center 10; and receives the acceptance point information J3 indicating the acceptance point delivered from the control center 10. A personal computer is used as this terminal device.

Various information is exchanged between the control center 10 and the medical practitioner 40 by use of a network such as the Internet. Therefore, the control center 10 establishes a Web site (Web control server) for receiving the order information J0 from the medical practitioner 40. So as to communicate with the Web site, software for executing a transmission/reception of information between the medical practitioner 40 and the control center 10 by use of a Web browser is previously installed in the personal computer as the terminal device provided to the medical practitioner 40. Thus, it is possible to execute an order sending/receipt processing on the Web browser. This software should be distributed gratis to each medical practitioner 40. Even a personal computer should be distributed gratis to the medical practitioner who has no personal computer on the condition that he/she will participate in this system (as personal computers are expensive). A medical billing calculation computer dealer may be commissioned to pre-install the software to the personal computer.

A terminal device for receiving delivery information J4 delivered from the control center 10 is provided at the distributor 30. A personal computer is used as this terminal device. The distribution of the delivery information J4 between the distributor 30 and the control center 10 is performed by use of a network such as the Internet.

Next, the flow of the various information and the goods (X-ray film) in the physical distribution system having the above-described constitution will be described.

The medical practitioner 40, that is, the customer, accesses the control center 10 by use of the personal computer and the Web browser, and inputs the order information J0, the acceptance area range information J1, and the deadline information J2 while viewing a browser screen.

At this time, various information is input in accordance with a menu on the browser screen. For example, it is desirable to display a list of candidate acceptance points including a plurality of acceptance points close to the location of the medical practitioner 40 on the browser screen and to select a plurality of desired acceptance points among them in accordance with the location of the medical practitioner 40. Moreover, a distance range from the location of the medical practitioner 40 may be input by the medical practitioner 40 to the personal computer. In the latter case, in order to allow a plurality of acceptance points to be included within the distance range input by the medical practitioner 40, the distance ranges that can be input to the personal computer in accordance with a relative location between the medical practitioner 40 and the delivery points (such as a convenience store CS) is changed for each medical practitioner 40. Moreover, a price list illustrating different costs in accordance with the range of the desired acceptance point and the range of the desired deadline is displayed on the browser screen, and the medical practitioner 40 is allowed to select the range of the acceptance point in consideration of the cost. It is satisfactory that the price list displays the cost of the X-ray film and the delivery cost individually, or alternatively that the price list displays the cost of the X-ray film including the delivery cost. The acceptance area range information J1 indicating the selected acceptance area range that is allowable for the medical practitioner 40 and the deadline information J2 indicating the range of the deadline are transferred to the control center 10 together with the order information J0.

When the control center 10 receives the order information J0, the acceptance area range information J1, and the deadline information J2, the control center 10 determines, by use of physical distribution control software, the acceptance point for each medical practitioner 40 among all of the acceptance points within the acceptance area range that is allowable for each medical practitioner 40 based on the acceptance area range information J1 and the deadline information J2, so that a delivery efficiency as a whole is enhanced in consideration for the total sum of the delivery distances, the delivery frequency, and the number of delivery destinations. The physical distribution cost for delivering the X-ray film having the model number and in the quantity desired by the medical practitioner 40 to the predetermined delivery point (acceptance point) within the acceptance area range that is allowable for the medical practitioner 40 is determined for each medical practitioner 40, so that the physical distribution cost becomes lower as the acceptance area range and the deadline range that are allowable for each medical practitioner 40 are wider. The control center 10 organizes all of the ordered goods desired by the medical practitioner 40 and instructs the manufacturer 20 to organize the ordered goods and to deliver them to the distributor 30 so that the total sum of the X-ray films becomes as large as possible within the range of the desired deadline. At the same time, the control center 10 transmits the delivery information J4 relating to the X-ray film, the quantities thereof, and the delivery date for each acceptance point to the distributor 30. Note that, X-ray film of a certain model number and the quantities thereof according to a sales forecast are previously delivered to the distributor 30 from the manufacturer 20 regardless of the orders of the medical practitioners 40, whereby it is possible to use the distributor 30 in place of a storehouse.

The control center 10 transmits the acceptance point information J3 indicating the determined acceptance point to the medical practitioner 40 who ordered the goods.

As shown in FIG. 1, since the acceptance area range information J1 entered by each of the medical practitioners 40 includes at least two candidates for the acceptance point, as for the medical practitioners 40 (for example, “a” and “b”) who entered the information J1 including the same acceptance point as the candidacy, it is possible to collectively deliver the X-ray films desired by these medical practitioners to the same acceptance point (the convenience store “b” in the former example) included in the information J1. Accordingly, the delivery frequency can be reduced, and the delivery efficiency can be enhanced. Specifically, within the acceptance area range and the deadline range previously allowed by the medical practitioners 40, it is possible for the manufacturer 20 and the control center 10, that is, the X-ray film supplier, to select an advantageous acceptance point from the viewpoint of the delivery efficiency.

The distributor 30 delivers the predetermined X-ray film and quantities thereof to the convenience store CS or the discount store DS as the predetermined acceptance point in accordance with the delivery information J4 transmitted from the control center 10.

Then, the convenience store CS or the discount store DS read out the bar codes attached to the products when the convenience store CS or the discount store DS receives the X-ray films from the distributor 30. Thus, the delivery process in this system is completed.

Note that the medical practitioner 40 who ordered the X-ray film should confirm his/her own acceptance point based on the acceptance point information J3 distributed from the control center 10, and go to the acceptance point on or after the deadline designated by himself/herself to accept the X-ray film.

As described above, according to the physical distribution system of this embodiment, since the goods (the X-ray film in this embodiment) desired by customers (the medical practitioners in this embodiment) are not delivered to each of the customers respectively, but collectively delivered to the predetermined acceptance point, the goods desired by the customers can be organized to at least the same acceptance point desired by the customers. Accordingly, the delivery efficiency is enhanced.

As in the foregoing embodiment, since a plurality of acceptance points are included in the acceptance area range that can be designated by the customer, it is possible for the goods provider to select a convenient acceptance point from the viewpoint of delivery efficiency within the acceptance area range allowed by the customers, so that the delivery efficiency can be further enhanced. In addition, if an acceptance point convenient for the goods provider is selected from the viewpoint of the delivery efficiency also in consideration of the deadline, the delivery efficiency can be further enhanced.

Furthermore, it is possible to provide services to reduce a product price in accordance with the enhancement of the delivery efficiency, the product price being one in which a delivery fee may or may not be included. In addition, as the customer visits the predetermined acceptance point to receive the goods, the final distribution expense can be suppressed. Accordingly, a total delivery cost can be reduced, and the customer also benefits from this system.

Moreover, in the case of the foregoing embodiment, it is possible to remove the conventional sales work to curry favor with physicians, and therefore the cost of the X-ray film can be reduced.

In the foregoing embodiment, since the goods are delivered to the predetermined acceptance point through no intermediate brokers such as agents, the order information can be used in the manufacturing process and the distribution process through the control center with a high efficiency. As a result, all information is collectively converted to the form of database in the control center, and this is useful for future business. For example, if a quantity of usage of the X-ray film is known, when it is tried to find a market for a CR system (such as those disclosed in Japanese Unexamined Patent Publication Nos. 55(1980)-12429 and 56(1981)-11395), sales targets determined depending on the performance of the CR system and the budget for it become clear. Moreover, it is possible to make a sales forecast for the CR system and to plan a strategy for it with a high degree of reliability. Furthermore, when the CR system is sold, it is possible to collect sales information relating to usage times of a DRY apparatus, a CR apparatus, or a CRT diagnosis apparatus and to expendable supplies such as the quantities of IP used, by connecting them to a personal computer in which control software is installed. In addition, it is also possible to provide direct mail services through a network, in which a customer's interest and reliance in the CR system can be obtained by executing Web transmission for new product information and product application information.

Furthermore, by adopting such a physical distribution system, the delivery of the goods requires no intermediate agents, and additional effects can be obtained such as that competitiveness can be maintained for price competition forecasted to occur in several years after comprehensive standardization of film (originally, the medical practitioner is concerned only with the price of the film). Specifically, since conventionally the goods are delivered to the customer through the intermediate brokers such as agents in the conventional physical distribution system, it is difficult to grasp sufficient customer information relating to the medical practitioner class. However, the trends of the medical practitioner class can be grasped quantitatively by operating the foregoing physical distribution system of the present invention, and effects of the physical distribution system of the present invention are immeasurable.

In this embodiment, as a technique to inform each customer of the acceptance point for said customer, one in which the control center informs the customer of the determined acceptance point is adopted. In addition, a method in which the customer is informed of the acceptance point when the goods arrive thereat can be adopted. Moreover, the customer can make a phone call to all of the acceptance points (candidates for the acceptance point) within the acceptance area range designated by the customer at the time of ordering, in order to confirm his/her own acceptance point, the appointed date, and the period during which time the goods are available for pick-up.

In the foregoing embodiment, as the method for delivering the goods between the acceptance point and the customer, one in which the customer visits the acceptance point to receive the goods is adopted. However, the present invention is not limited to this method; the goods may be delivered from the acceptance point to the customer in response to a demand from the customer. In this case, the goods originally to be received at the acceptance point by the customer are sent to the customer after the goods arrive at the acceptance point. This means a demand for changing the delivery style, and the goods provider does not bear responsibility for the delivery between the acceptance point and the customer, in other words, the delivery between the acceptance point and the customer is outside the scope of the physical distribution system of the present invention.

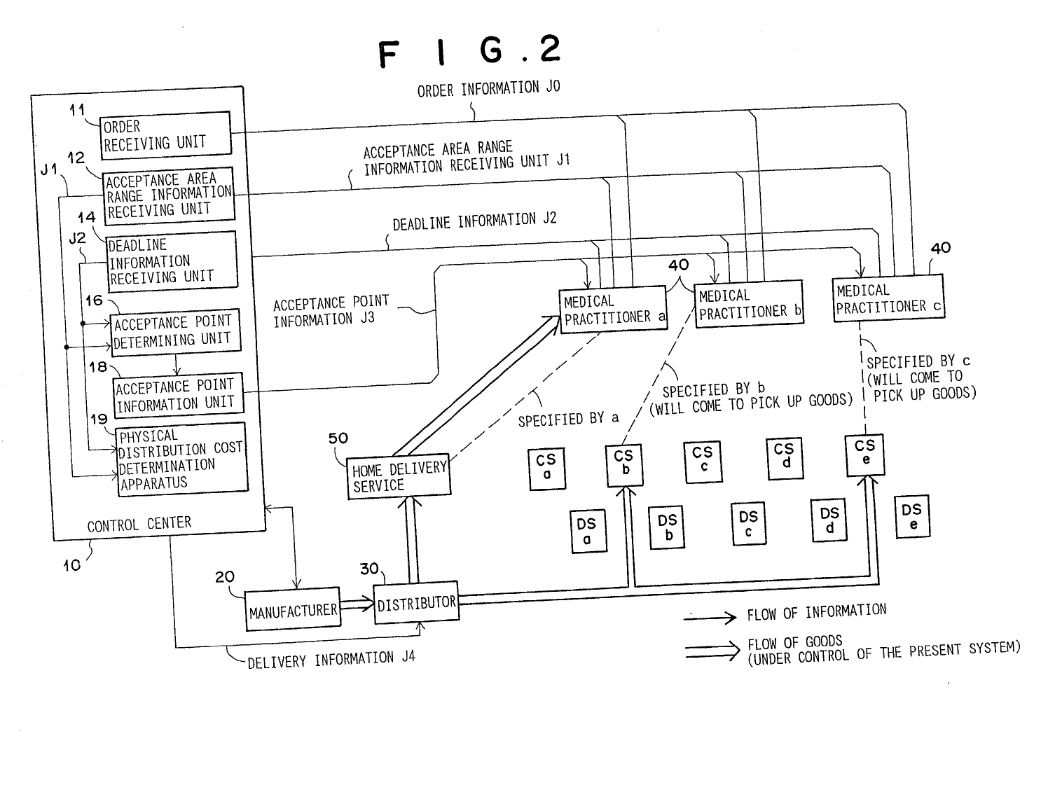

Next, a physical distribution system of a second embodiment of the present invention will be described. FIG. 2 is a conceptual diagram showing the physical distribution system of the second embodiment.

As shown in FIG. 2, a home delivery service 50 is added to the physical distribution system. The constituent components and the connection styles in the system constitution are approximately identical to those in the first embodiment. However, the acceptance area range information receiving unit 12 is different from that of the first embodiment as follows. A plurality of delivery points are not included as candidates of actual acceptance points within the acceptance area range that are allowable for the medical practitioner 40, but the unit 12 allows the medical practitioner 40 to select either to order the home delivery service 50 to deliver the goods to the medical practitioner 40 or to order the distributor 30 to deliver the goods to only one designated acceptance point such as a convenience store CS.

The physical distribution cost determination unit 19 determines a physical distribution cost for each medical practitioner 40, the physical distribution cost being for the delivery of the X-ray film desired by the medical practitioner 40 and delivered in a manner designated by the medical practitioner 40. In the second embodiment, the physical distribution cost determination unit 19 sets the price of the X-ray film so that the price thereof is quite different depending on whether the home delivery service 50 delivers the X-ray film to the medical practitioner 40 or the medical practitioner 40 visits the designated acceptance point to receive the X-ray film.

In the case of the physical distribution system of the second embodiment, though it is impossible to determine the acceptance point most convenient for the goods provider from the viewpoint of the delivery efficiency within the acceptance area range allowed by the customer as in the first embodiment, the goods desired by each customer (the X-ray film in the second embodiment) can be at least deposited at the acceptance point collectively, and hence the delivery efficiency can be further enhanced.

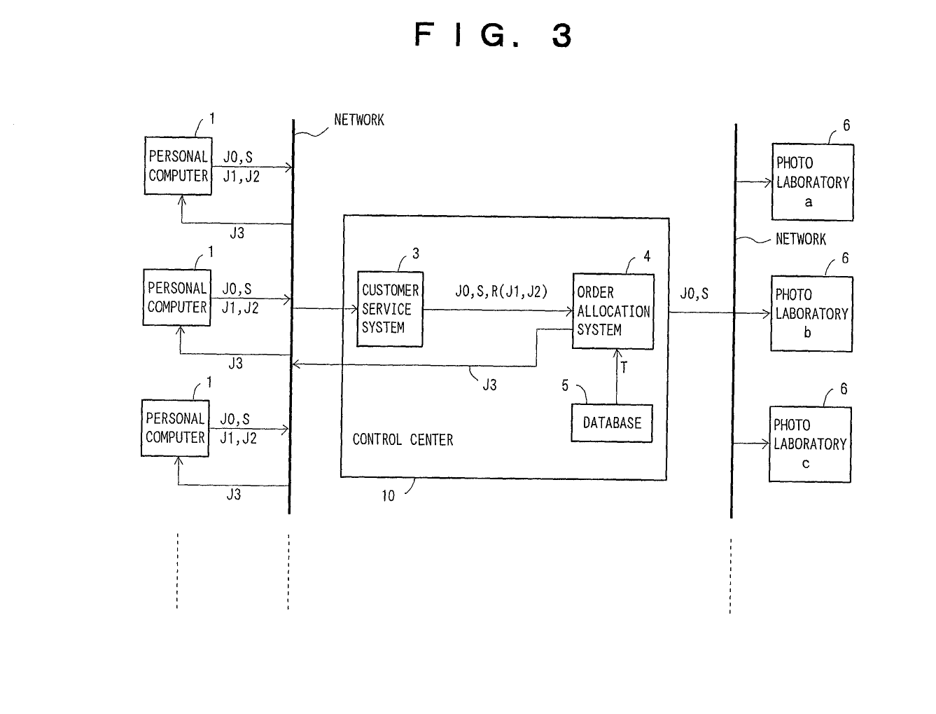

Next, an embodiment of a photograph image outputting system of the present invention and an embodiment of a physical distribution cost determination apparatus of the present invention will be described. FIG. 3 is a conceptual diagram showing an embodiment of the photograph image outputting system.

In the foregoing physical distribution systems, a consumer item desired by the customer is goods such as IP, and the goods are delivered either to an area range desired by the customer or to the designated acceptance point. This photograph image outputting system offers a digital photograph service by use of a network, and the consumer item desired by the customer is a photograph image output. The photograph image outputting is performed within an area range desired by the customer or at a designated laboratory.

The photograph image outputting includes the following various processes related to the photograph image in addition to printing of photographs (so-called hardcopy outputting). Specifically, there are various processes including recording of an image data to a CD-ROM; registering of an image in a laboratory-server; a photography process, based on order information from a user, such as extra printing, preparation of a post card with a photograph, preparation of a photo album, composition of images, and trimming, which are performed for image data; transferring of the processed data to the user; and informing the user of completion of the processes by electronic mail. A laboratory designates a place where the photograph image outputting is carried out. As long as the laboratory has this meaning, its style is overlooked. For example, a control center for controlling a digital photograph service system sometimes functions as the laboratory. In the following descriptions, a printing system for performing a photograph printing service at a laboratory such as printing of an image photographed by a digital camera is described as the photograph image outputting system of the present invention.

As shown in FIG. 3, the components that constitute the printing system of the present embodiment and the connection methods thereof are approximately identical to those in the first embodiment. To be specific, the printing system is constituted by connecting personal computers 1 possessed by users with a control center 10 including a customer service system 3 and an order allocation system 4 through a network, and by connecting the control center 10 with laboratories 6 (a to c) through a network. A constitution may be adopted, in which a plurality of customer service systems are provided instead of the control center 10; and the personal computers 1, the plurality of customer service systems, the order allocation system 4, and the laboratories 6 are connected through the network. A correlation between the present embodiment and the first embodiment will be briefly described.

The user, who has a personal computer 1 as an input terminal device, corresponds to the medical practitioner 40. The laboratory 6 corresponds to the delivery point of the goods (the delivery destination point and the acceptance point).

In the control center 10 which functions also as the physical distribution cost determination apparatus, a control server (control computer) which functions as the customer service system 3 and the order allocation system 4 is set up.

The customer service system 3 functions as an order receiving unit for receiving the order information J0 relating to the photograph image output desired by the user, an acceptance area range information receiving unit for receiving the acceptance area range information J1 relating to the acceptance area range that is allowable for the user, and a deadline information receiving unit for receiving the deadline information J2 relating to the deadline that is allowable for the user. The order allocation system 4 functions as: an acceptance laboratory determination unit for determining a laboratory for each user among all of the laboratories, at which the photograph image is to be received, within the acceptance area range that is allowable for the user based on the acceptance area range information J1 and the deadline information J2 of the user received, so that an outputting efficiency of the photograph image is enhanced as a whole; an acceptance laboratory informing unit for informing the user of acceptance laboratory information J3 relating to the determined laboratory at which the photograph image is to be received by the user; and a physical distribution cost determination unit for determining the physical distribution cost for outputting the photograph image desired by the user based on the acceptance area range information J1 and the deadline information J2 of the user, so that the cost becomes lower as the acceptance area range and the deadline range, which are allowable for the user, are wider. The acceptance laboratory determining unit corresponds to the acceptance point determining unit 14. The acceptance laboratory informing unit corresponds to the acceptance point informing unit 18.

The control center 10 establishes a Web site as the customer service system 3 on the network, which receives order information J0 from the user. As this Web site, one which the user joins as a member can be used, including a site performing mail-order sales, a site providing various information services, and a site of a provider which the user joins.

Image data S possessed by the user is stored in the personal computer 1, and the user accesses the customer service system 3 by use of the Web browser of the personal computer 1. The user describes the contents of the print order of the image data S and transfers the order information J0 and the image data S to the customer service system 3. At this time, the user also inputs the acceptance area range and the deadline which he/she wishes, and transfers also the acceptance area range information J1 relating to the acceptance area range and the deadline information J2 relating to the deadline to the customer service system 3.

Upon receiving the image data S and the order information J0, the customer service system 3 outputs the image data S and the order information J0 accompanied with distribution information R to the order allocation system 4. The distribution information R is that referred to when the order allocation system 4 allocates the orders, and may be the foregoing acceptance area range information J1 and the foregoing deadline information J2 itself. Moreover, the distribution information R may be other information derived from the acceptance area range information J1 and the deadline information J2.

A database 5 is connected to the order allocation system 4, and a table T indicating the relation between the distribution information R and each of the laboratories 6 is stored in the database 5. The table T includes data showing a distance between the location of the user and the location of each laboratory, the acceptance area range information J1, the deadline information J2, and the cost of the print outputting corresponding thereto.

When the order allocation system 4 receives the image data S, the order information J0, and the distribution information R from the customer service system 3, the order allocation service system 4 refers to the table T stored in the data base 5 based on the distribution information R, i.e., the acceptance area range information J1 and the deadline information J2, and selects, for each user, a laboratory 6 among the laboratories 6a to 6c, to perform printing based on the order information J0. Then, the order allocation system 4 transfers the image data S and the order information J0 to the selected laboratory 6. The order allocation system 4 also determines the cost for each user for performing the print outputting desired by the user, so that the cost becomes lower as the acceptance area range and the deadline range, which are allowable for the user, are wider. Furthermore, the order allocation system 4 transfers to each user the acceptance laboratory information J3 relating to the selected laboratory for said user.

When selecting the laboratory, based on the acceptance area range information J1 and the deadline information J2 of the user which are received, the order allocation system 4 determines for each user the laboratory at which the user receives the photograph image among all of the laboratories within the acceptance area range and the deadline range which are allowable for the user, so that the outputting efficiency (printing efficiency) of the photograph image is enhanced as a whole.

A printer for performing the print outputting based on the image data S is provided in the laboratory 6, and the printer receives the order information J0 and the image data S which are transmitted from the order allocation system 4. The printer performs the print outputting in accordance with the order information J0.

As described above, since the printing system of this embodiment is constructed so that the plurality of laboratories as acceptance points are included in the acceptance area range that can be designated by the user, it is possible to select, within the range previously allowed by the user, a laboratory which is convenient for the print service provider from the viewpoint of the outputting efficiency. In addition, if the printing system of this embodiment is constructed so that a laboratory convenient for the service provider also in terms of the deadline is selected, it is possible to further enhance the outputting efficiency. To be specific, the laboratory convenient for the print service provider is selected within the range allowable for the user, and hence the data transfer and the like can be carried out with a high efficiency, resulting in an improvement of the print outputting efficiency.

The service in which the printing cost is made to be lower in accordance with the improvement of the outputting efficiency can be provided. Furthermore, since the customer visits the predetermined laboratory to receive the print output, a final distribution expense can be suppressed, and hence a total printing service cost can be reduced, leading to great merit for the customer.

Although the preferred embodiments of the physical distribution system, the photograph image outputting system, and the physical distribution cost determination apparatus for use in these systems of the present invention were described in the above, the present invention is not always limited to the above-described embodiments.

For example, the idea of performing the high-efficiency distribution and print outputting by selecting the delivery destination and the laboratory convenient for the provider within the range allowable for the customer (user) can be applied to an order outputting control system (supply management system) which manufactures a consumer item which the customer desires in response to an order of the customer and distributes the products.

For example, provided is an order outputting control system which enables customers to accept consumer items such as goods ordered by the customers at an output destination, for example, an acceptance point within a range desired by the customers, and which enables the customers to pay for the goods there, that is, the order outputting control system which outputs the consumer products desired by a plurality of customers at the predetermined output destination. The order outputting control system comprises an acceptance area range information receiving unit for receiving information relating to an acceptance area range that is allowable for a plurality of customers; and an acceptance point determining unit for determining, based on the information relating to the acceptance area range allowable for each of the customers, an output destination at which each customer accepts a consumer item among all of the output destinations within the acceptance area range allowable for each customer, so that the outputting efficiency of the demands is enhanced as a whole, wherein outputting of each consumer item desired by each customer is performed at the determined output destination.

The words “outputting” and “output destination” which are defined depending on a consumer item as in the above described examples of delivery and acceptance point or outputting of a photographic image and a laboratory representatively mean the following operations, including a pair of the delivery of the goods and the acceptance point (delivery destination), and a pair of outputting of the photograph image and the laboratory. For example, when the consumer item is a postal item, “outputting” is delivery of said postal item, and “output destination” is a post office. When the demand is a printed matter, “outputting” is a printing action, and “output destination” is a printing shop.

The acceptance area range information receiving unit should allow a plurality of output destinations (candidates for the output destination) to be included within the acceptance area range allowable for the customer.

As determination criteria for enhancing the outputting efficiency of the demand as a whole, there are, for example, a total sum of outputting times and a total number of the output destinations. The output destination for each customer should be determined so that an outputting cost in total becomes lower for the provider by reducing the total sum of the outputting times and the number of the output destinations.

The order outputting control system of the present invention further comprises a deadline information receiving unit for receiving information relating to a deadline allowable for the customer, and the acceptance point determining unit should determine the output destination for each customer at which the customer receives the consumer item based on the information received relating to the deadline.

The order outputting control system of the present invention further comprises an acceptance laboratory informing unit for informing the customer of the determined laboratory at which the customer receives the photograph image.

When each customer is informed of the output destination at which said customer is to receive the photograph image, it is desirable to inform a date (output date) when outputting of the consumer item is completed at the output destination and a period of time during which said photographic image are available for pick-up.

A consumer item outputting cost determination apparatus used in the order outputting control system for outputting consumer items desired by a plurality of customers at a predetermined output destination, comprises: an acceptance area range information receiving unit for receiving information relating to an acceptance area range allowable for each customer; and a physical distribution cost determination unit for determining, based on the received information relating to the acceptance area range allowable for each customer, a physical distribution cost, the physical distribution cost being for outputting of the consumer item desired by the customer, so that the physical distribution cost becomes lower as the acceptance area range allowable for the customer becomes wider.

The sentence “so that the physical distribution cost becomes lower as the acceptance area range allowable for the customer becomes wider” means that the physical distribution cost becomes lower as the number of the output destinations (candidates for the output destination for outputting of the consumer item) included in the acceptance area range allowable for the customer is larger.

The consumer item outputting cost determination apparatus of the present invention further comprises a deadline information receiving unit for receiving information relating to a deadline allowable for the customer, and the physical distribution cost determination unit should determine for each customer the physical distribution cost for outputting of the consumer item desired by the customer, based on the received information relating to the deadline, so that the physical distribution cost becomes lower as the range of the deadline is wider.

What is claimed is:

1. A physical distribution system for delivering goods desired by a plurality of customers from a supply origin which supplies the goods to a predetermined acceptance point, comprising:
an acceptance area range information receiving unit for receiving information relating to an acceptance area range that is allowable for a plurality of customers to accept the goods; and
an acceptance point determining unit for determining an acceptance point for each customer from among all of the acceptance points within the acceptance area range allowable for said customer based on the information received relating to the acceptance area range allowable for said customer, so that a delivery efficiency is enhanced as a whole,
wherein the goods desired by the customer is delivered to the determined acceptance point.

2. The physical distribution system according to claim 1,
the physical distribution system further comprising:
a deadline information receiving unit for receiving information relating to a deadline allowable for the customer,
wherein the acceptance point determining unit determines the acceptance point for each customer based on the information received relating to the deadline.

3. The physical distribution system according to one of claims 1 and 2,
the physical distribution system further comprising:
an acceptance point informing unit for informing each customer of the acceptance point determined for said customer.

4. A physical distribution cost determination apparatus used for a physical distribution system which delivers goods desired by a plurality of customers to a predetermined acceptance point from a supply origin supplying the goods,
the physical distribution cost determination apparatus comprising:
an acceptance area range information receiving unit for receiving information relating to an acceptance area range allowable for a plurality of customers; and
a physical distribution cost determination unit for determining, based on the received information relating to the acceptance area range allowable for each customer, a physical distribution cost for each customer, the physical distribution cost being for a delivery of the goods desired by the customer to the determined acceptance point within the acceptance area range allowable for the customer, so that the physical distribution cost becomes lower as the acceptance area range allowable for the customer becomes wider.

5. The physical distribution cost determination apparatus according to claim 4,
the physical distribution cost determination apparatus further comprising:
a deadline information receiving unit for receiving information relating to a deadline allowable for each customer,
wherein the physical distribution cost determination unit determines the physical distribution cost for each customer based on the received information relating to the deadline, so that the physical distribution cost becomes lower as the time period specified by the customer during which he is able to come to the acceptance point to receive the goods to be delivered thereto becomes wider.

6. A photograph image outputting system which performs outputting of photograph images desired by a plurality of customers at a laboratory,
the photograph image outputting system comprising:
an acceptance area range information receiving unit for receiving information relating to an acceptance area range allowable for a plurality of customers; and
an acceptance point determining unit for determining, based on the information received relating to the acceptance area range allowable for each customer, a laboratory for each customer, at which the customer receives the photograph image, among all of the laboratories within the acceptance area range allowable for the customer, so that an outputting efficiency of the photograph image is enhanced as a whole,
wherein outputting of the photograph image desired by the customer is performed at the determined laboratory.

7. The photograph image outputting system according to claim 6,
the photograph image outputting system further comprising:
a deadline information receiving unit for receiving information relating to a deadline allowable for the customer,
wherein the acceptance point determining unit determines, based on the information received relating to the deadline, a laboratory for each customer, at which the customer receives the photograph image, so that the outputting efficiency is enhanced as a whole.

8. The photograph image outputting system according to claim 7,
the photograph image outputting system further comprising:
an acceptance laboratory informing unit for informing the customer of the laboratory determined for each customer, at which the customer receives the photograph image.

9. A photograph image outputting cost determination apparatus used for a photograph image outputting system which performs outputting of a photograph image desired by a plurality of customers at a predetermined laboratory, the photograph image outputting cost determination apparatus comprising:
an acceptance area range information receiving unit for receiving information relating to an acceptance area range allowable for a plurality of customers; and
a physical distribution cost determination unit for determining, based on the received information relating to the acceptance area range allowable for each customer, a physical distribution cost for each customer, the physical distribution cost being that for outputting of the photograph image desired by the customer, so that the physical distribution cost becomes lower as the acceptance area range allowable for the customer is wider.

10. The photograph image outputting cost determination apparatus according to claim 9,
the photograph image outputting cost determination apparatus further comprising:
a deadline information receiving unit for receiving information relating to a deadline allowable for each customer,
wherein the physical distribution cost determination unit determines, based on the information received relating to the deadline, the physical distribution cost for outputting of the photograph image desired by each customer, so that the physical distribution cost becomes lower as the time period specified by the customer during which he is able to come to the acceptance point to receive the photograph image to be delivered thereto becomes wider.
